(19) United States
(12) Patent Application Publication
(10) Pub. No.: US 2016/0343069 A1
(43) Pub. Date: Nov. 24, 2016

(54) Online Auction System with Rolling End Time

(71) Applicant: Archon Information Systems, L.L.C., New Orleans, LA (US)

(72) Inventors: Bryan BARRIOS, Thibodaux, LA (US); Brian DANOS, Metairie, LA (US); William D. SOSSAMON, New Orleans, LA (US)

(73) Assignee: Archon Information Systems, L.L.C., New Orleans, LA (US)

(21) Appl. No.: 15/159,513

(22) Filed: May 19, 2016

Related U.S. Application Data
(60) Provisional application No. 62/163,752, filed on May 19, 2015.
(60) Provisional application No. 62/185,974, filed on Jun. 29, 2015.
(60) Provisional application No. 62/189,849, filed on Jul. 8, 2015.

(51) Int. Cl. G06Q 30/08; G06Q 20/20

(52) U.S. Cl. CPC G06Q 30/08; G06Q 20/207

(57) ABSTRACT

A method of completing the sale of tax adjudicated properties that ensures compliance with legal requirements for these types of sales, wherein the method driven by market interest in the tax adjudicated property, the auction end time is rolling, and bidders are given one or more warnings of the impending end time to allow them to make last minute bids.

### CROSS-REFERENCE TO RELATED APPLICATIONS

This application claims the benefit of U.S. Provisional Patent Applications Ser. No. 62/163,752, filed on May 19, 2015; and, 62/185,974, filed on Jun. 29, 2015; and 62/189,849, filed on Jul. 8, 2015. Priority of U.S. Provisional Patent Applications Ser. No. 62/163,752, filed on May 19, 2015; and, 62/185,974, filed on Jun. 29, 2015; and 62/189,849, filed on Jul. 8, 2015 is hereby claimed.

Our prior patent applications, including U.S. patent application Ser. No. 13/746,136, filed on Jan. 21, 2013, and which claims the benefit of U.S. Provisional Patent Application Ser. No. 61/588,863, filed on Jan. 20, 2012; U.S. Provisional Patent Application Ser. No. 62/163,752, filed on May 19, 2015; and, U.S. Provisional Patent Application Ser. No. 62/185,974, filed on Jun. 29, 2015, are incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to an improved online auction system. More particularly, the present invention relates to an improved online auction system for the market-driven sale of tax-distressed property of behalf of tax recipient bodies where the end time for the auction is a non-static time, dependent on when the last bid has been placed, and wherein bidders are given a pop-up warning of the impending end time similar to warnings one would receive at a live auction.

2. General Background of the Invention

Ad Valorem tax collectors are tasked with collecting taxes from the constituency. The tax collection process requires the tax collector to notify the property owner of his, her or its total tax obligation, and if a constituent does not pay the tax obligation, then the tax collector prepares the property for auction in order to satisfy the outstanding tax liability. The legal obligations of the tax collector for preparing a property for tax sale differ by state, but all tax collectors are obligated to satisfy federal law relative to due process and deprivation of property.

The most significant component of the tax sale process is ensuring proper notice to all owners, co-owners and interested parties (lien holders, etc.). Once all notification requirements have been met, the tax collector must host a public auction. Generally the auction occurs at the local court house or approved annex and is held within hours dictated by local and or state laws. This requires the tax collector to provide personnel to manage the auction registration, auctioneering, bid confirmation and payment acceptance. The length of an auction is relative to the speed at which bidding occurs and the number of properties that are available. It is not uncommon to host an analog tax sale auction over the course of several days.

At the conclusion of the auction, the results are tabulated and payments and or payment arrangements are recorded. Legal documents are drafted and signed to complete the sale and satisfy the outstanding tax obligation.

In most instances only a fraction of the properties offered at an analog tax sale are indeed sold; the properties that do not generate bids are stricken/adjudicated to the tax authority and become a non-tax revenue generating liability, and all costs associated with the tax sale preparation are simply not recovered unless an additional effort is made to host a stricken/adjudicated property sale. Therefore, there is a need for a tax sale process wherein the process for preparing a property for sale is driven by market interest in the property so that the tax collector does not incur the costs of the preparation process for a property that will not be sold.

There are online auction sites, such as ebay, for selling items online. There are also online auction sites to sell municipal bonds, for example. However, these online auction sites are not able to assign a rolling end time that is dependent on the bidders themselves as with typical live auctions. Additionally, the warning for an end time is generally a countdown clock in online auction sites that counts down to a predetermined end time. However, because internet speeds vary, the final seconds are often inaccurate on these countdown clocks and bidders may rely on the clock to their detriment believing that 2 or 3 seconds remain in the auction when it has actually already ended. As such, there is also a need for an online auction system wherein the end time is rolling and changes depending on the bidding process, and wherein warnings for the end of the auction are provided in a manner that does not include a countdown clock in order to prevent inaccuracy due to varying internet speeds, and detrimental reliance on an inaccurate countdown.

The following U.S. patents are incorporated herein by reference:
U.S. Provisional Patent Application Ser. No. 61/588,863, filed on Jan. 20, 2012;
U.S. patent application Ser. No. 13/746,136, filed on Jan. 21, 2013;
U.S. Provisional Patent Application Ser. No. 62/163,752, filed on May 19, 2015; and
U.S. Provisional Patent Application Ser. No. 62/185,974, filed on Jun. 29, 2015.

### BRIEF SUMMARY OF THE INVENTION

The present invention is an online auction system for the market-driven sale of tax-distressed property of behalf of tax recipient bodies; particularly tax foreclosure, tax deed and tax adjudicated properties.

The present invention is an improvement over previous inventions disclosed in U.S. patent application Ser. No. 13/746,136, filed on Jan. 21, 2013, and incorporated herein by reference, in that the market determines which properties will be vetted for possible sale, and the end time of the auction is rolling.

The present invention is an improvement over previous inventions disclosed in U.S. Provisional Patent Application Ser. No. 62/163,752, filed on May 19, 2015; and U.S. Provisional Patent Application Ser. No. 62/185,974, filed on Jun. 29, 2015 in that the bidder is given warnings of the impending end time allowing for follow-up bids and resulting in extension of the end time.

This improvement preferably causes the following to occur during auction. Sometime near the end of the bidding, preferably shortly (for example 30 or 40 seconds) before the first bidding period is over or the (for example 5 minute) extended period is over, there can be a pop up, for example “Going Once”, over the property undergoing auction, then when closer (for example 15 or 20 seconds later), for example “Going Twice” (if no intervening bid), then, for example “Sold”, at the end of the initial bidding period or extended bidding period. This system is useful in that if one attempts to, for example instead, rely on a countdown timer, the countdown timer due to delays in internet transmission may not have exactly the correct time left. This improved system is a less precise, yet more useful warning that time is about to run out.

The following US patents and patent application Publications are incorporated herein by reference: U.S. Pat. Nos. 8,660,908; 8,521,610; 2014/0143081; 2013/0218708; 2008/0235126.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIGS. 1-9 are screen shots showing preferred embodiments of the process of the present invention.

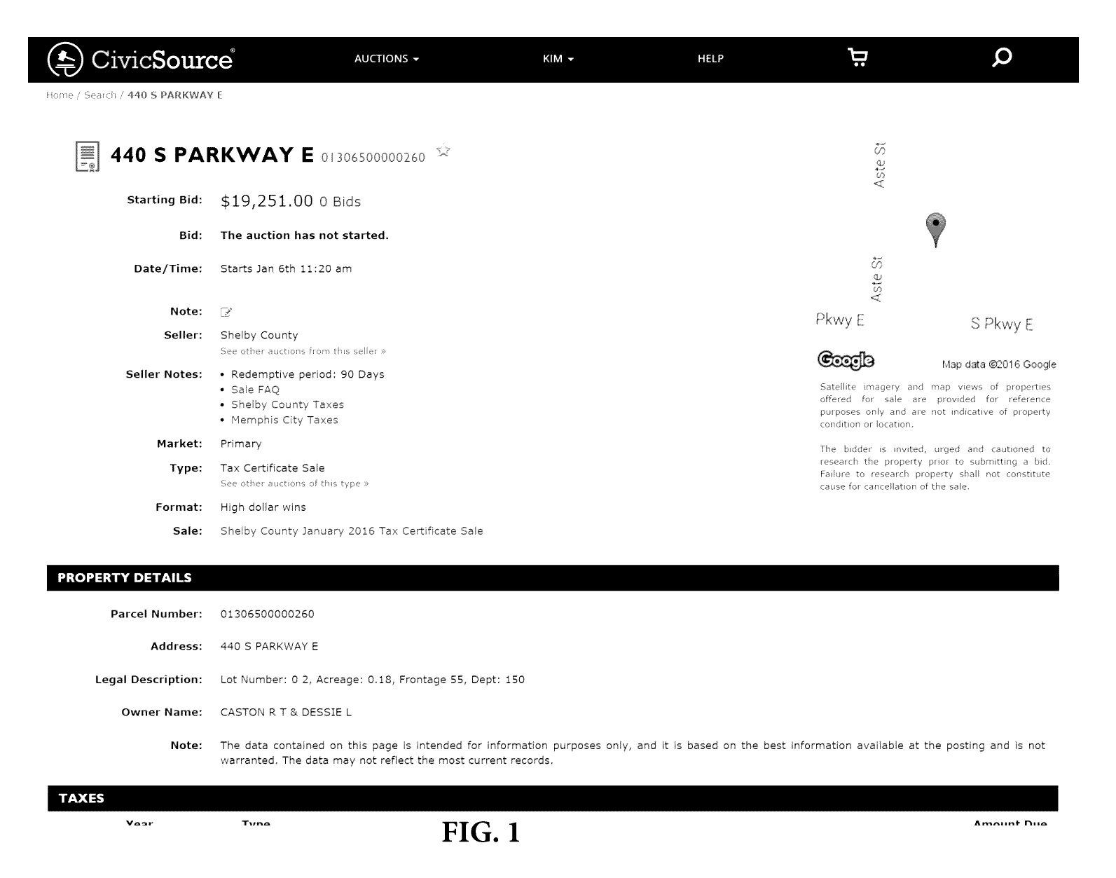

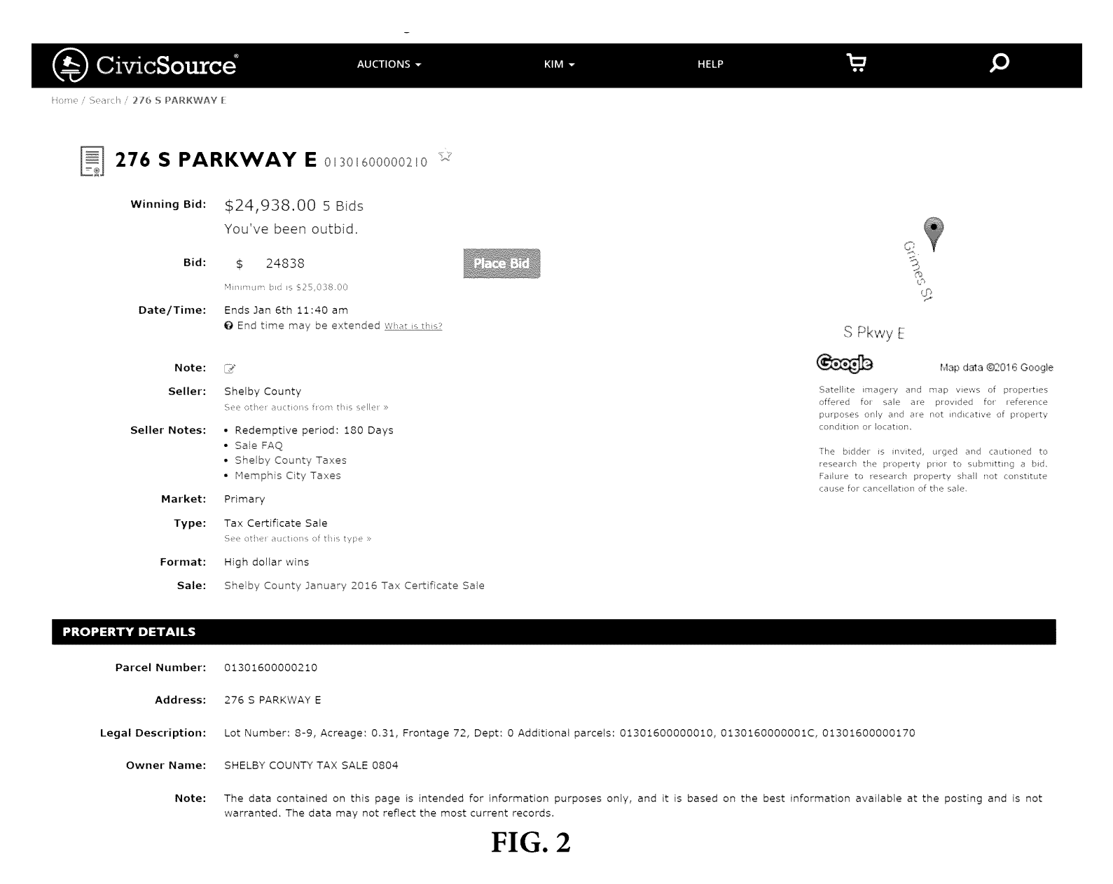

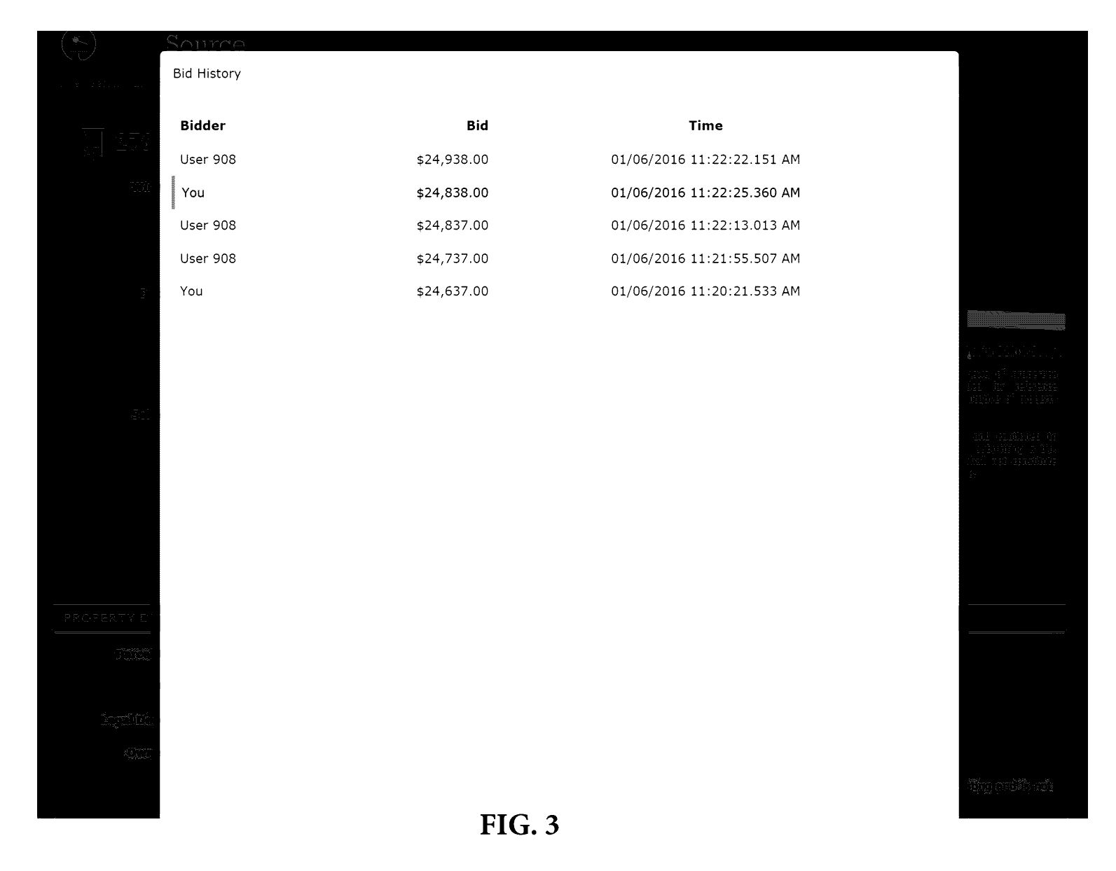

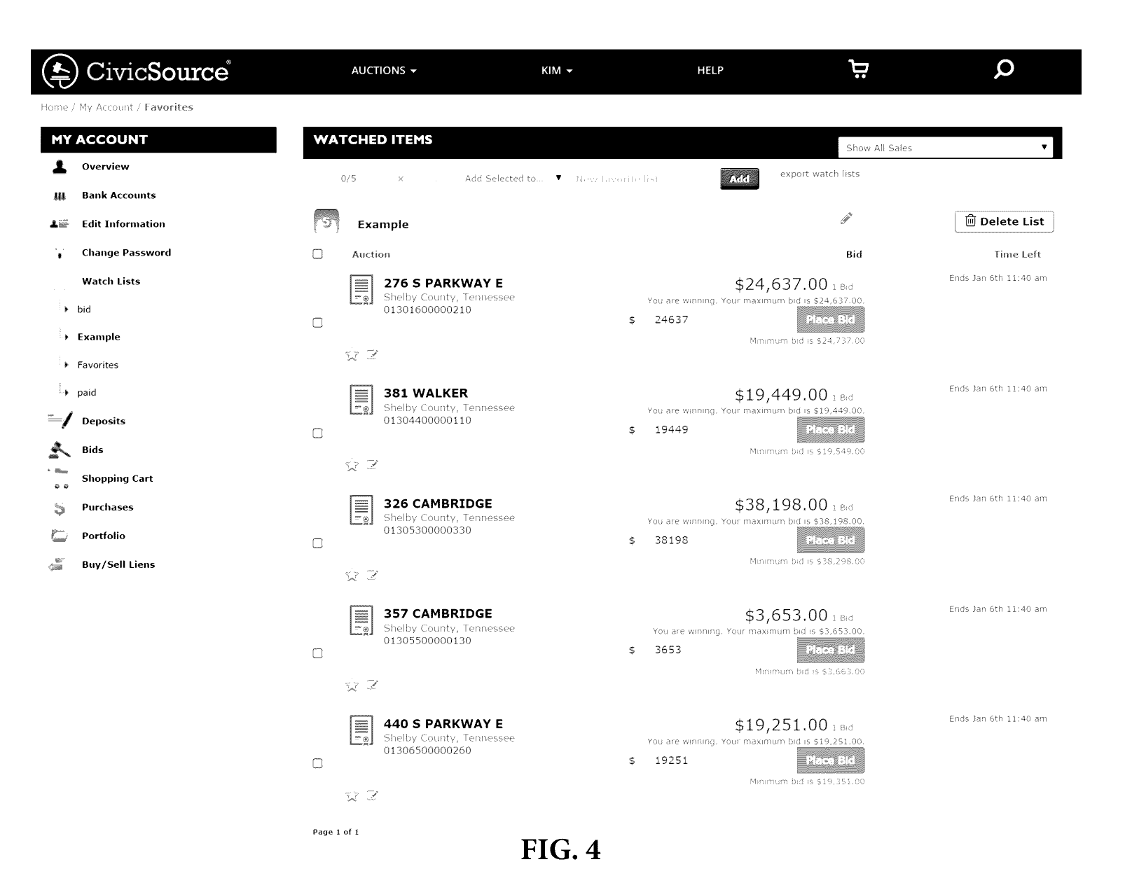

### DETAILED DESCRIPTION OF THE INVENTION

The attached drawings provide examples of preferred embodiments of the present invention.

More particularly, the present invention comprises a method of selling property online on behalf of property tax recipient bodies comprising at least the following steps:

(a) importing data about the property;

(b) encoding fees;

(c) allowing the property data to go live to potential buyers;

(d) collecting a deposit from the buyer;

(e) performing a title search on the property;

(f) providing a legally required due process notice of the pending sale to all parties of interest;

(g) scheduling a sale date;

(h) conducting an online sale of the property on the scheduled sale date; and

(i) establishing an end time for the auction.

The present invention further includes software for carrying out the method, and a data processor that runs said software, wherein the software is embodied in a computer readable storage medium that is coupled to the data processor.

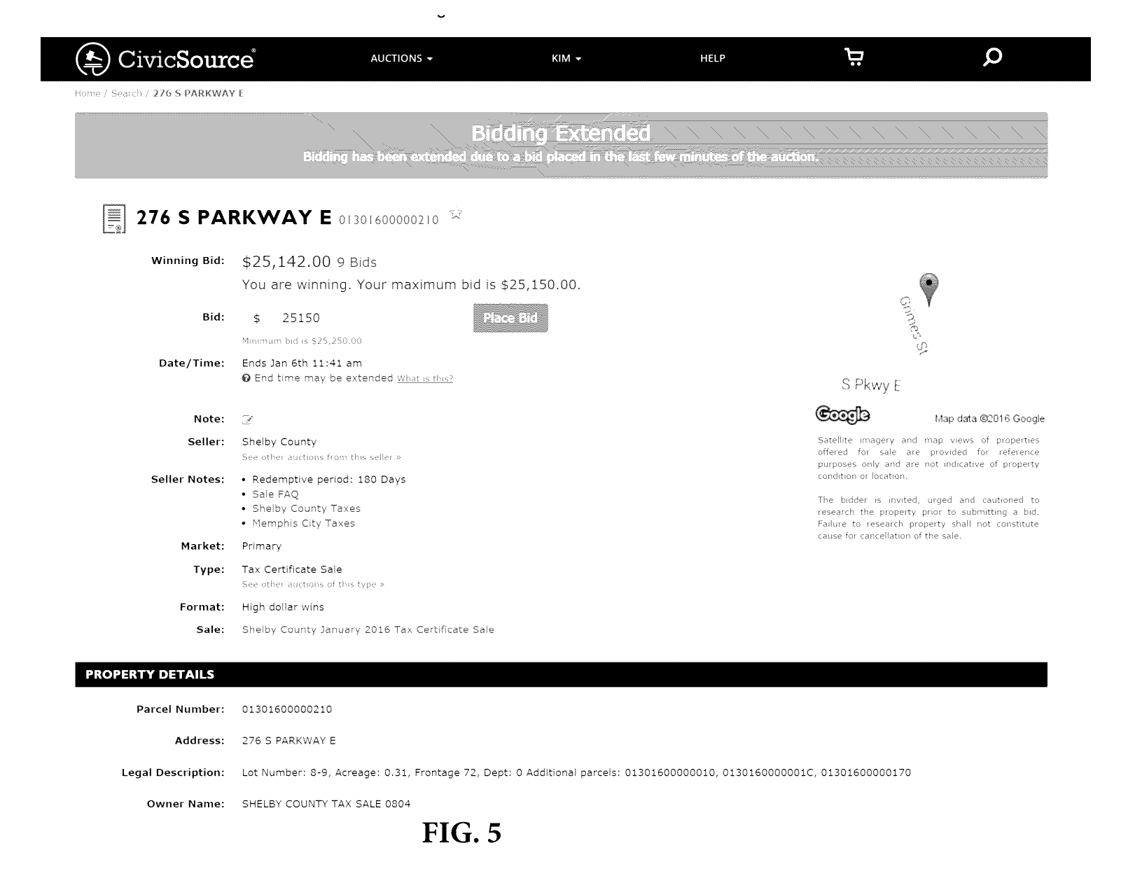

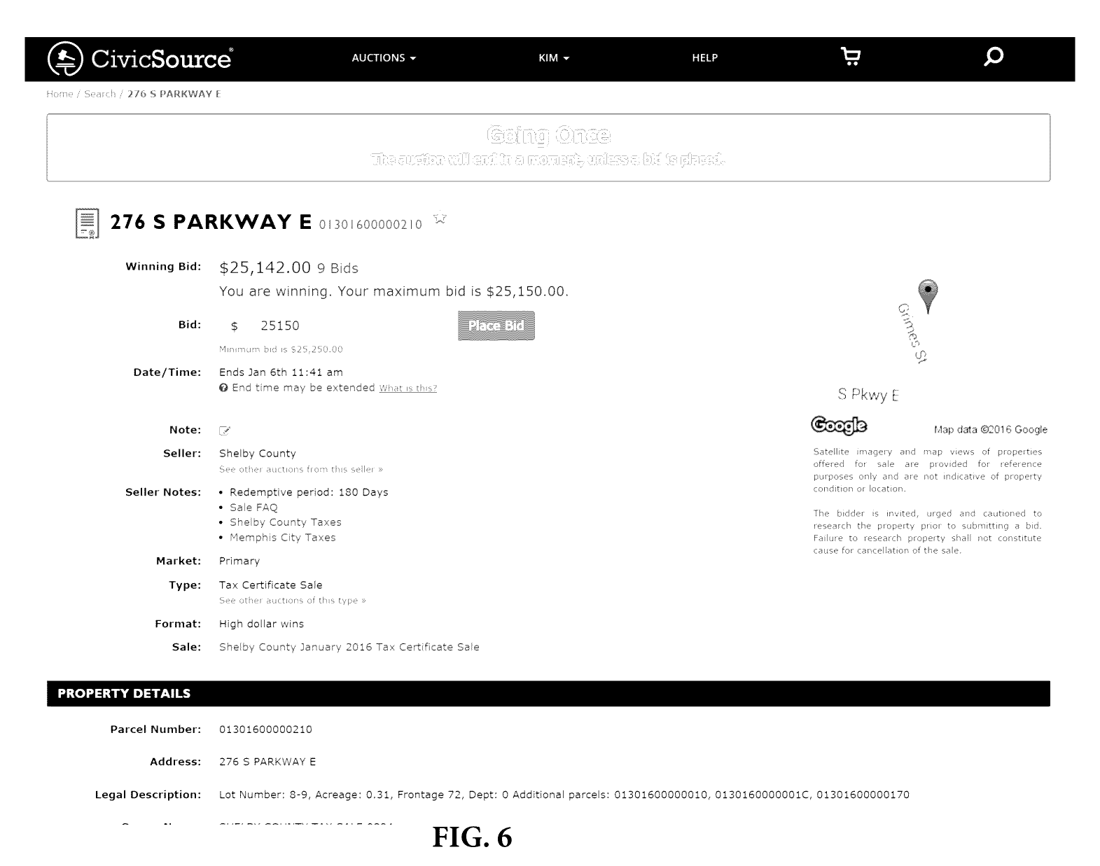

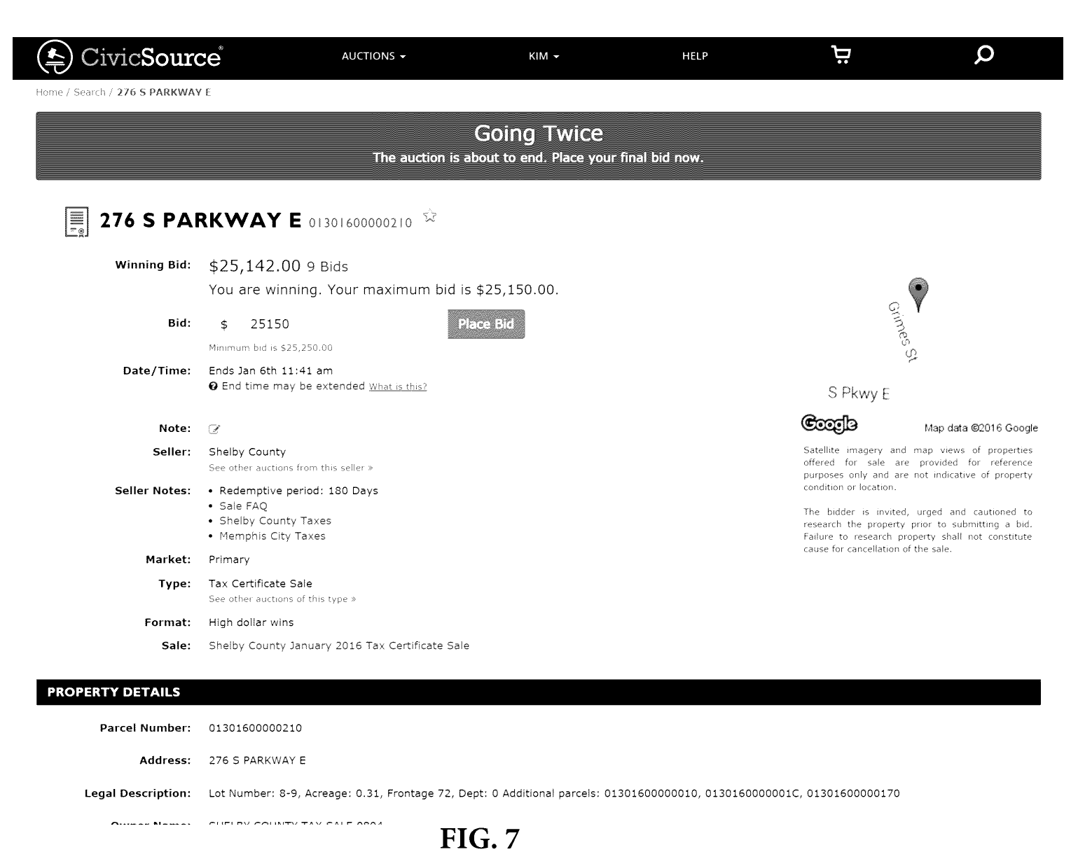

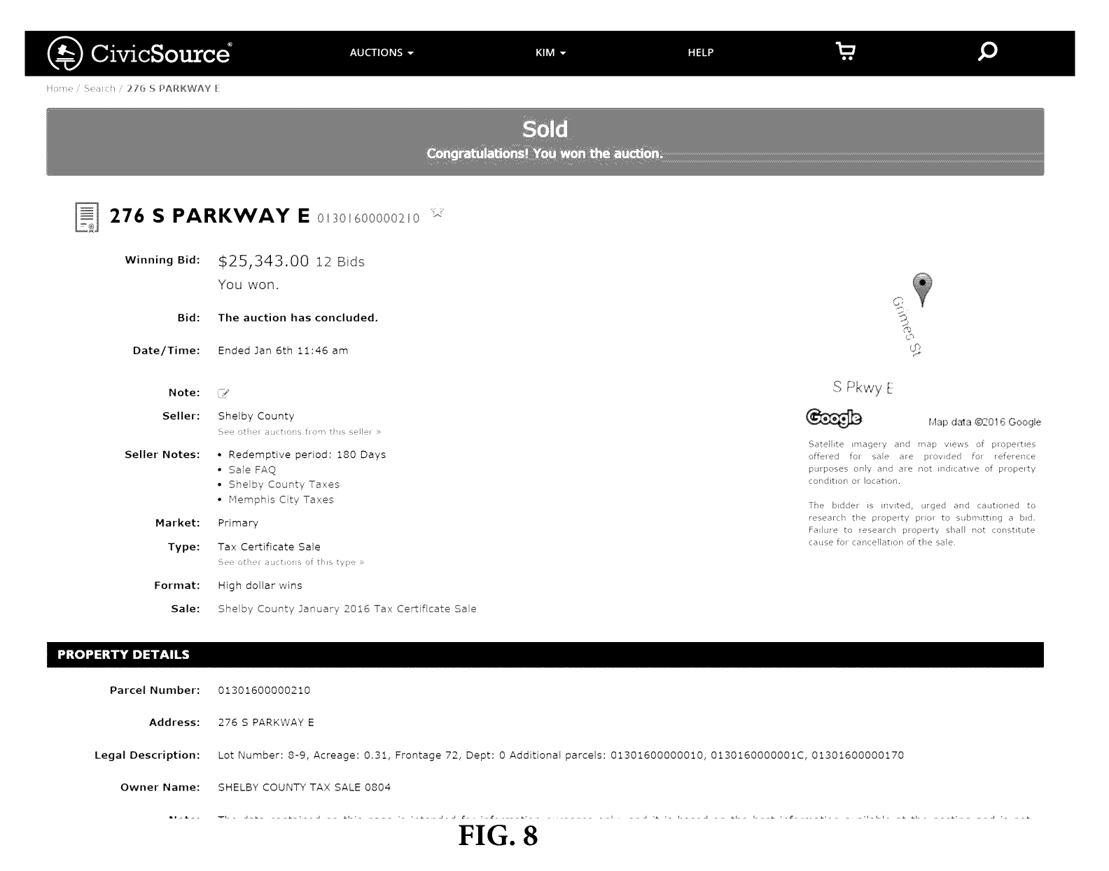

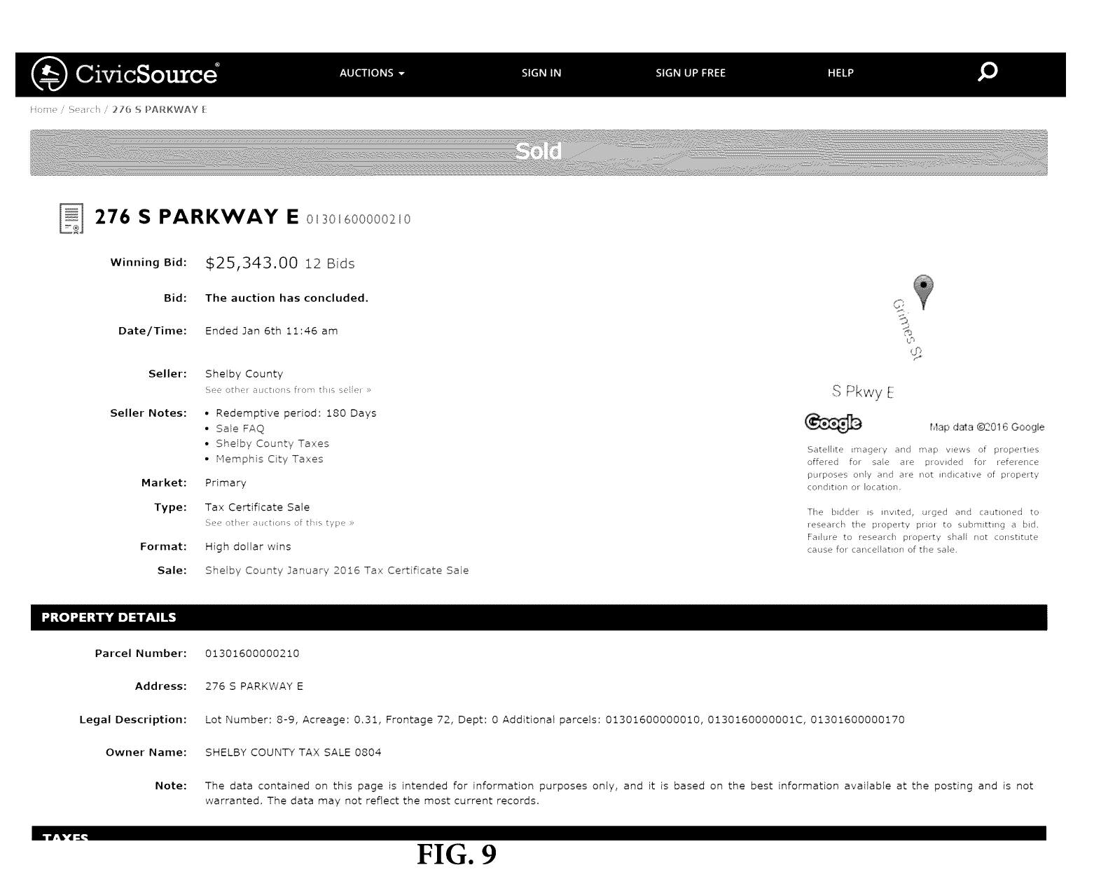

Step (i) in this method is preferably programmed to change throughout the auction according to bids entered. More preferably, the auction is scheduled to end at either (a) a predetermined date and time, or (b) a set period of time following the last bid entered, whichever is later. The predetermined end time in alternative (a) may be, for example, (1) 24-72 hours after the first bid is entered, (2) at the close of business 1-7 days after the first bid is entered, (3) 24-72 hours after the auction begins, or (4) at the close of business 1-7 days after the auction begins. The set period of time in alternative (b) may be, for example, 1-15 minutes after the last bid that was entered. See FIGS. 5-7, and 12. As an example, an auction may be set to end either 24 hours after it begins, or 5 minutes after the last bid is entered. If the auction begins at 10 am on Tuesday, it will end at 10 am on Wednesday, unless a bid is entered between 9:55 am and 9:59 am on Wednesday, in which case the auction end time will be extended to 5 minutes after the last bid. This extension will continue as more bids come in, allowing bidding to continue until no additional bids are received for 5 minutes time. This improvement allows the tax adjudicator to get the maximum value for the property and prevents an opportunistic bidder from waiting until the last seconds of the auction to enter an only slightly higher bid for the property.

In a preferred embodiment, bidders are given one or more warnings that the auction end time is approaching, preferably similar to those heard at a live auction. See FIGS. 12-15. The warning may be, for example, by way of a pop-up text box over the property that is the subject of the auction. Preferably, the warning does not give a specific time period remaining, but instead lets the bidders know that the auction is nearing its close, to prevent bidders from relying on an exact time that may not be accurate based on time differences due to internet transmission of information. Preferably, at least two warnings are given. For example, and similar to a live auction, the first warning may say “going once . . . ” (as shown in FIG. 13) and is preferably followed by a second warning a short period of time later saying “going twice . . . ” (as shown in FIG. 14), with the end of the auction signaled by a third pop-up, preferably saying “SOLD” (as shown in FIG. 15). Also similar to a live auction, new bids received during this warning period will preferably result in extension of the auction end time, and also preferably reset the warning system (as shown in FIG. 12). For example, if a new bid is received after the first “going once . . . ” pop-up warning, the auction end time will be extended by a pre-selected time period, for example 3-5 minutes, and the pop-up warnings to bidders will cease until the new end time approaches.

The method of the present invention is preferably carried out at no cost to the tax recipient body.

The method of the present invention may further comprise a step between steps (a) and (b) of developing a price strategy.

The method of the present invention may further comprise a step between steps (b) and (c) of receiving client approval of the price strategy and data.

The method of the present invention may further comprise a step between steps (c) and (d) of accepting a buyer's offer for sale.

The method of the present invention may further comprise a final step of providing the buyer with a certificate of non-warranty cash sale.

The present invention also includes a method of selling online property on behalf of property tax recipient bodies at no cost to the tax recipient body comprising at least the following steps:

(a) importing data about the property;

(b) developing a pricing strategy;

(c) encoding fees;

(d) receiving client approval of the pricing strategy and data;

(e) allowing the property data to go live to potential buyers;

(f) accepting a buyer's offer for sale;

(g) collecting a deposit from the buyer;

(h) performing a title search on the property;

(i) providing a legally required due process notice of the pending sale to all parties of interest;

(j) scheduling a sale date;

(k) conducting an online sale of the property on the scheduled sale date; and

(l) providing the buyer with a certificate of non-warranty cash sale.

The present invention also includes software for carrying out the methods recited above. The software is meant to be run on a computer processor and improves the functioning of the computer by programming for intuitive searches, market driven choice of properties for auction, and rolling adjusted end times for auction based on the current activity of the ongoing bidding process. The software is preferably embodied in a computer readable storage medium that is coupled to the data processor.

Preferably, the software programs the computer to determine what legally required notice is required based on the laws of one of the 50 United States of America.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of selling property online on behalf of property tax recipient bodies comprising at least the following steps:
(a) importing data about the property;
(b) encoding fees;
(c) allowing the property data to go live to potential buyers;
(d) collecting a deposit from the buyer;
(e) performing a title search on the property;
(f) providing a legally required due process notice of the pending sale to all parties of interest;
(g) scheduling a sale date;
(h) conducting an online sale of the property on the scheduled sale date; and
(i) establishing an end time for the auction.

2. The method of claim 1, wherein step (i) is programmed to change throughout the auction according to bids entered.

3. The method of claim 2 wherein the end time is scheduled in the alternative for (a) a predetermined date and time, or (b) a preselected period after the last bid entered, whichever falls later.

4. The method of claim 3 wherein bidders are given one or more warnings of that the auction end time is approaching.

5-6. (canceled)

7. The method of claim 4 wherein a first warning, a second warning, and a closing message are given.

8. (canceled)

9. The method of claim 7 wherein the first warning is given approximately 45-60 seconds before auction end, the second warning is given approximately 25-45 seconds before auction end, and the closing message is given 1-5 seconds after the auction ends.

10. The method of claim 4 wherein new bids received in response to the warnings cause the end time of the auction to be extended and also cause the warning system to reset.

11-16. (canceled)

17. A method of selling online property on behalf of property tax recipient bodies at no cost to the tax recipient body comprising at least the following steps:
(a) importing data about the property;
(b) developing a pricing strategy;
(c) encoding fees;
(d) receiving client approval of the pricing strategy and data;
(e) allowing the property data to go live to potential buyers;
(f) accepting a buyer's offer for sale;
(g) collecting a deposit from the buyer;
(h) performing a title search on the property;
(i) providing a legally required due process notice of the pending sale to all parties of interest;
(j) scheduling a sale date;
(k) conducting an online sale of the property on the scheduled sale date; and
(l) providing the buyer with a certificate of non-warranty cash sale.

18-20. (canceled)

21. A system of selling property online on behalf of property tax recipient bodies comprising:
software for preparing and auctioning the property to satisfy unpaid taxes, the software comprising:
(a) a means for importing data about the property;
(b) a means for encoding fees;
(c) a means for allowing the property data to go live to potential buyers;
(d) a means for collecting a deposit from the buyer;
(e) a means for performing a title search on the property;
(f) a means for providing a legally required due process notice of the pending sale to all parties of interest;
(g) a means for scheduling a sale date;
(h) a means for conducting an online sale of the property on the scheduled sale date; and
(i) a means for establishing an end time for the auction;
a data processor that runs said software, wherein the software is embodied in a computer readable storage medium that is coupled to the data processor.

22. The system of claim 21 wherein the software is programmed so that step (i) continuously changes the established end time throughout the auction according to bids entered.

23. The system of claim 22 wherein the software is programmed to schedule the end time in the alternative for (i) a predetermined date and time, or (ii) a preselected period after the last bid entered, whichever falls later.

24. The system of claim 23 wherein the software further comprises a means for providing bidders with one or more warnings that the auction end time is approaching.

25-26. (canceled)

27. The system of claim 24 wherein the one or more warnings comprise a first warning, a second warning, and a closing message.

28. (canceled)

29. The system of claim 27 wherein the first warning is given approximately 45-60 seconds before auction end, the second warning is given approximately 25-45 seconds before auction end, and the closing message is given 1-5 seconds after the auction ends.

30. The system of claim 24 wherein the software is programmed such that new bids received in response to the one or more warnings cause the end time of the auction established in step (i) to be extended and also cause the means for providing one or more warnings to reset.

31-32. (canceled)

33. The system of claim 21, wherein the software further comprises means to developing a price strategy, the developing taking place between steps (a) and (b).

34. The system of claim 33, wherein the software further comprises means of receiving client approval of the price strategy and data, the receiving taking place between steps (b) and (c).

35. The system of claim 21, wherein the software further comprises means of accepting a buyer's offer for sale, the accepting taking place between steps (c) and (d).

36. The system of claim 21, wherein the software further comprises means of providing the buyer with a certificate of non warranty cash sale.

37. (canceled)

38. The method of claim 7 wherein new bids received in response to the warnings cause the end time of the auction to be extended and also cause the warning system to reset.
